(19) United States
(12) Patent Application Publication
(10) Pub. No.: US 2012/0256922 A1
(43) Pub. Date: Oct. 11, 2012

(54) Multithreaded Processor and Method for Realizing Functions of Central Processing Unit and Graphics Processing Unit

(76) Inventor: Simon MOY, Mountain View, CA (US)

(21) Appl. No.: 13/242,334

(22) Filed: Sep. 23, 2011

(30) Foreign Application Priority Data
Apr. 8, 2011 (CN) 201110088661.0

(51) Int. Cl. G06T 15/50; G06F 15/80

(52) U.S. Cl. 345/426; 345/505

(57) ABSTRACT

A multithreaded processor and method for realizing the functions of a central processing unit and a graphics processing unit, including a graphics fixed function processing module for performing a fixed function processing on data during a graphics processing, a multithreaded parallel central processing module for realizing a central processing function and a programmable processing function of a graphics processing through a uniform thread scheduling and exchanging the graphics data subjected to the programmable processing with the graphics fixed function processing module through a storage module, and a storage module for providing a uniform storage space for the graphics fixed function processing module and the multithreaded parallel central processing module to store, buffer and/or exchange data. The multithreaded processor and method for realizing the functions of a central processing unit and a graphics processing unit allow load balancing among multiple thread processing engines.

### FIELD OF THE INVENTION

The present invention relates to an integrated circuit and more particularly to a multithreaded processor and method for realizing the functions of a central processing unit and a graphics processing unit.

### BACKGROUND OF THE INVENTION

Central processing unit (CPU) and graphics processing unit (GPU) are two most important integrated circuit chips in most computer systems including PC and portable devices. Conventionally, a CPU and a GPU are two independent chips that are connected with each other via a standard bus. Recently, the functions of the two chips have been integrated in one encapsulation to lower the cost. Specifically, the integration is realized by configuring a CPU bare chip and a GPU bare chip in the same encapsulation or placing the complete kernels of a CPU and a GPU in the same encapsulation. A CPU and a GPU are still independent from each other in terms of structure and design no matter which one of the aforementioned methods is adopted, and the resources for realizing the functions of the CPU and the GPU are separated or independent from each other as well. The conventional design and improvements thereof both bring about a relatively large silicon wafer usage area, and additionally, the improvements further cause an unbalance in the loads of a CPU and a GPU, one of the CPU and the GPU being busy while the other one being completely idle, which causes a resource waste.

### SUMMARY OF THE INVENTION

In order to address the problems of high cost and unbalanced load existing in prior art, the present invention provides a multithreaded processor and method for realizing the functions of a central processing unit and a graphics processing unit with low cost and relatively balanced load.

The technical solution adopted by the present invention for addressing the problems above is to construct a multithreaded processor for realizing the functions of a central processing unit and a graphics processing unit, which comprises:

a graphics fixed function processing module performing a fixed function processing on data during a graphics processing;

a multithreaded parallel central processing module for realizing a central processing function and a programmable processing function of a graphics processing through a uniform thread scheduling and exchanging the graphics data subjected to the programmable processing with the graphics fixed function processing module through a storage module; and

a storage module for providing a uniform storage space for the graphics fixed function processing module and the multithreaded parallel central processing module to store, buffer and/or exchange data.

In the multithreaded processor described in the present invention, the graphics fixed function processing module is an independent ASIC which exchanges data with the multithreaded parallel central processing module via the storage module.

In the multithreaded processor described in the present invention, the programmable processing on graphics data comprises a vertex shading and/or a pixel shading on graphics data; and the graphics fixed function processing module is connected with the multithreaded parallel central processing module via an L2 cache.

In the multithreaded processor described in the present invention, the graphics fixed function processing module is controlled by, or sends an interruption request to the multithreaded parallel central processing module via an interruption control interface configured in the multithreaded parallel central processing module.

In the multithreaded processor described in the present invention, the multithreaded parallel central processing module is a multithreaded virtual pipeline processor.

In the multithreaded processor described in the present invention, the multithreaded virtual pipeline processor comprises two parallel multithreaded virtual pipeline processing kernels.

In the multithreaded processor described in the present invention, each of the parallel multithreaded virtual pipeline processing kernels comprises:

multiple parallel thread processing engines for processing a task or thread distributed thereto;

a thread controller for acquiring, determining and controlling the states of the multiple thread processing engines and distributing the threads or tasks in a waiting queue to the multiple thread processing engines;

a local storage area for storing the data processed by the thread processing engines and cooperating with the thread processing engines to complete a data processing; and

a register for the data buffering and the thread buffering of an internal storage system and the storage of various states of the parallel processor.

In the multithreaded processor described in the present invention, the thread processing engines each comprise an arithmetical logic operation unit and a multiplier-adder corresponding to the arithmetical logic operation unit; the local storage area comprises multiple local storage units which are configured to correspond to the thread processing engines when the thread processing engines are running.

The present invention further discloses a data processing method for realizing the functions of a central processing unit and a graphics processing unit, comprising the next steps of:

A) executing a main graphics processing application program while continuing other central processing application programs;

B) generating multiple tasks or data by the main graphics processing application program;

C) distributing the graphics data or task to be processed and other central processing application programs into multiple kernels and establishing a kernel queue;

D) determining whether or not a kernel is ready, if so, executing the next step, otherwise, repeating this step;

E) determining whether or not a thread resource is ready to run the kernels, if so, instantiating the kernels and executing the next step, otherwise, repeating this step; and

F) performing a programmable function processing on the data or risk.

In the method described in the present invention, the graphics processing further comprises a step of:

F) performing a fixed function processing on the graphics data subjected to the programmable function processing; or

G) performing a programmable function processing on the graphics data subjected to the fixed function processing.

In the method described in the present invention, the programmable function processing comprises a vertex shading and/or a pixel shading, and the fixed function processing comprises latticing, texturing and rasterizing.

In the method described in the present invention, the step C) further comprises the next steps of:

C1) distributing the graphics data to be processed to idle kernels and configuring a shader to process the graphics data in the kernels; and

C2) arranging the kernels into a kernel queue to be processed.

In the method described in the present invention, the step D) further comprises the next steps of:

D1) determining whether or not there is an idle thread resource, if so, executing the next step, otherwise, repeating this step; and

D2) configuring the kernels in the queue to the thread resource and starting to run the thread resource.

In the method described in the present invention, the graphics data fixed function processing part is a hardware structure which is independent from the kernels of the processor and connected with the kernels of the processor via an L2 cache of the processor.

In the method described in the present invention, the step G) further comprises the next steps of:

G1) sending the graphics data subjected to the programmable function processing to the L2 cache; and

G2) reading, by the graphics data fixed function processing part, data from the L2 cache, and processing the data.

In the method described in the present invention, in the step H), the graphics data fixed function processing part sends an interruption signal to the processor so as to send the graphics data to the processor by reading the data in the L2 cache to enable a programmable function processing.

The multithreaded processor and method disclosed in the present invention for realizing the functions of a central processing unit and a graphics processing unit have the following benefit effect: as the functions of a CPU and a GPU are achieved on a single processor architecture, the silicon wafer usage area is relatively small, additionally, as the programmable function of the GPU is realized in a thread processing way combining the data processing of the CPU, multiple parallel multi-thread virtual pipeline (MVP) kernels are used in the data processing of the CPU, and each MVP kernel comprises multiple parallel thread processing engines, a load balance is achieved among the multiple thread processing engines.

### BRIEF DESCRIPTION OF THE DRAWINGS

FIG. 1 is a schematic diagram illustrating the structure of a processor according to an embodiment of the multithreaded processor and method for realizing the functions of a central processing unit and an image processor disclosed in the present invention;

FIG. 2 is a schematic diagram illustrating the hardware structure of a single MVP kernel used in the embodiment;

FIG. 3 is a schematic diagram illustrating an interface for a graphics programmable function processing module and a graphics fixed function processing module used in the embodiment;

FIG. 4 is a flow chart of a graphics processing method used in the embodiment;

FIG. 5 is a schematic diagram illustrating the relationship between a graphics programmable function processing module and a graphics fixed function processing module used in the embodiment;

FIG. 6 is a schematic diagram illustrating the distribution of threads at a given moment in the embodiment; and

FIG. 7 is a schematic diagram illustrating the working procedure of a thread within a given period of time in the embodiment.

### DETAILED DESCRIPTION OF THE PREFERRED EMBODIMENT

The embodiments of the present invention are described below in detail with reference to accompanying drawings.

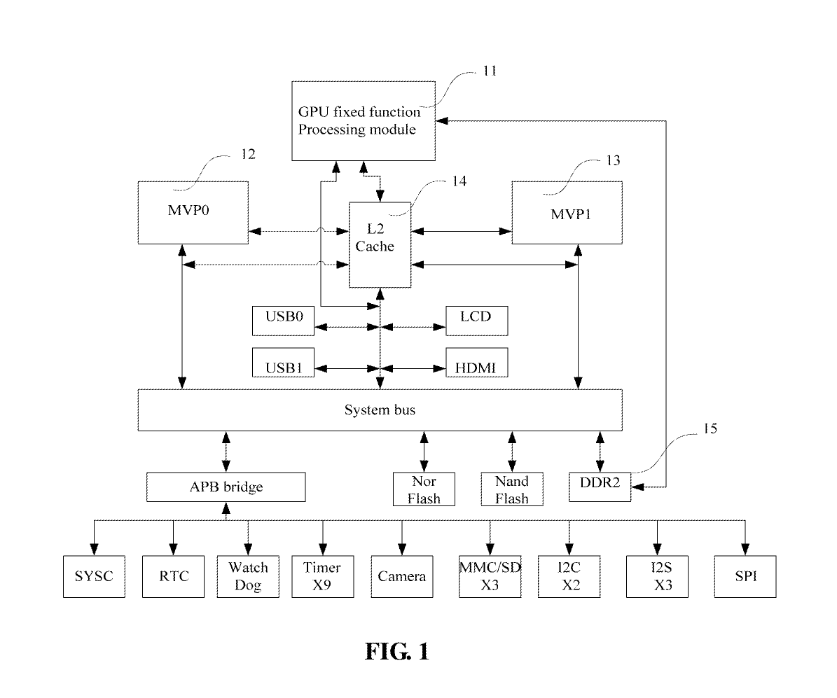

As shown in FIG. 1, in an embodiment of the multithreaded processor and method disclosed in the present invention for realizing the functions of a central processing unit and a graphics processing unit, the multithreaded processor comprises a graphics fixed function processing module 11, a multithreaded parallel central processing module and a storage module; the multithreaded parallel central processing module shown in FIG. 1 comprises two multi-thread virtual pipeline (MVP) kernels: MVP0 12 and MVP 1 13; the storage module comprises the L2 cache 14 and the DDR 2 15 shown in FIG. 1 which are connected with the graphics fixed function processing module 11 and the multithreaded parallel central processing module via a bus to provide a uniform storage space for the graphics fixed function processing module 11 and the multithreaded parallel central processing module to store, buffer and/or exchange data; the graphics fixed function processing module 11 is used performing a fixed function processing on data during a graphics processing; the multithreaded parallel central processing module is used for realizing a program processing function and a programmable processing function of a graphics processing through a uniform thread scheduling and exchanging the graphics data subjected to the programmable processing with the graphics fixed function processing module 11 through the storage module (specifically, the L2 cache 14).

In the embodiment, the graphics fixed function processing module 11 is a hardware structure independent from the MVP kernels (12, 13). That is, the graphics fixed function processing module 11 is an ASIC plug-in on the MVP kernels, as the graphics fixed function processing module 11 has relatively fixed functions and a relatively mature circuit structure and requires a calculation amount that is not large, an independent ASIC is relatively practical. In the embodiment, the graphics fixed function processing module 11 is connected with the L2 cache 14 via a bus AHB 3, and the L2 cache 14 is respectively connected with the MVP 0 12 and the MVP 1 13 via the bus, then, no matter in which one of the two MVP kernels the programmable function processing on graphics data is executed, a data exchange between the L2 cache 14 and the graphics fixed function processing module 11 can be realized. Additionally, the graphics fixed function processing module 11 is further connected with a system bus and a DDR 2 15 to facilitate a data output and a data input. And similarly, the two MVP kernels are connected with the L2 cache 14 and the system bus.

In the embodiment, the fixed function processing on graphics data comprises latticing, texturing and rasterizing; and the programmable function processing on graphics data mainly comprises a vertex shading on data and a pixel shading. The graphics programmable function processing is realized, by using one or more threads in the two MVP kernels, in the two MVP kernels in a program or user program processing way; if the graphics data subjected to the programmable function processing further needs a fixed function processing, the data is written into the L2 cache 14 and the graphics fixed function processing module 11 is informed of the data writing, then the graphics fixed function processing module 11 reads the data and performs a required processing and then outputs the data or returns the data to a thread in the MVP kernel for a subsequent processing.

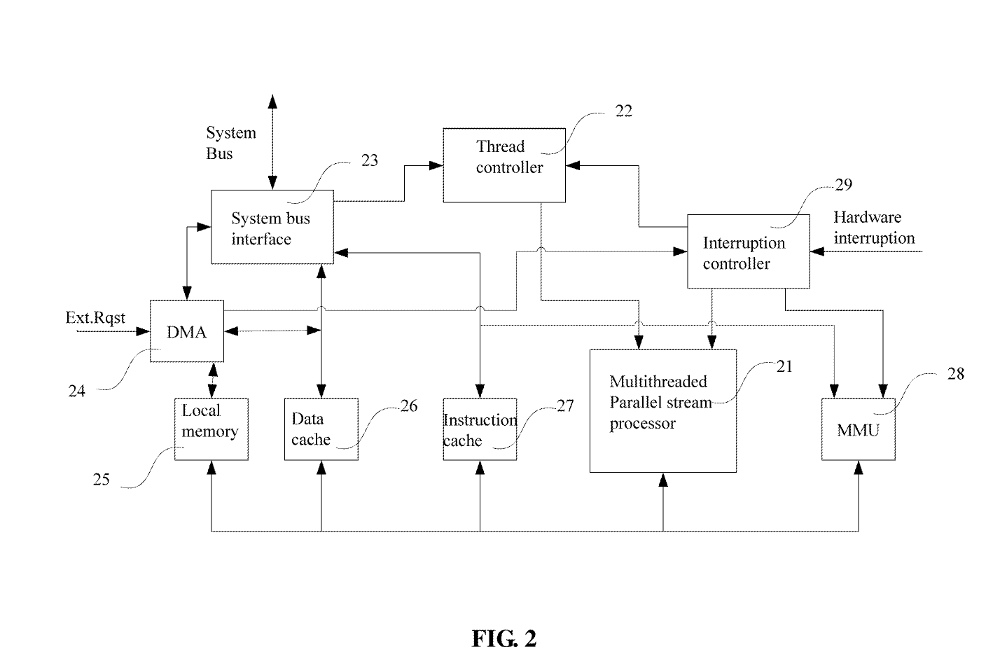

FIG. 2 shows the specific structure of an MVP kernel. As shown in FIG. 2, a multithreaded parallel stream data processing unit 21, a thread controller 22, a system bus interface 23, a dynamic memory access (DMA) controller 24, a local memory 25, a data cache 26, an instruction cache 27, a memory management unit (MMU) 28 and an interruption controller 29 are contained in an MVP kernel, wherein the multithreaded parallel stream data processing unit 21, which is used for processing a task or data thread distributed thereto, includes multiple parallel thread processing engines for running part of the threads or tasks distributed thereto, wherein after the running of a thread is completed, the thread processing engine running the thread is released and then distributed with another thread to be run. The thread controller 22 is used for acquiring, determining and controlling the states of the multiple thread processing engines and distributing the threads or tasks in a wait queue to the multiple thread processing engines; the local storage area, which consists of multiple local memories, is used for storing the data processed by the thread processing engines and cooperating with the thread processing engines to complete a data processing. In the embodiment, the local memories are configured in all the thread processing engines. During each processing on different data, only the local storage area configured by a thread processing engine is changed, without actually transferring the data stored in the local storage area. Besides, a register is further contained in an MVP kernel which is used for the data, thread and instruction buffering of an internal storage system and the storage of various states of the parallel processor. In the embodiment, the register comprises a data cache 26, an instruction cache 27, an MMU 28, an interruption controller 29 and a DMA 24.

In the embodiment, the thread processing engine comprises an arithmetical logic operation unit and a multiplier-adder corresponding to the arithmetical logic operation unit; the local storage area comprises multiple local storage units (namely, local memories) which are configured to correspond to the thread processing engines when the thread processing engines are running. Overall, the MVP kernel and the multithreaded parallel stream data processing unit located in the MVP kernel are substantially identical, in structure and data processing way, to the counterparts described in a Chinese patent No. 200910190339.1 entitled ‘parallel processor and thread processing method thereof’ and a Chinese patent No. 200910188409.X entitled ‘stream data processing method and stream data processor’. The specific structure and workflow of the MVP kernel can be appreciated by reference to corresponding description in the two aforementioned patent applications. And the MPV kernel is only described briefly in this application.

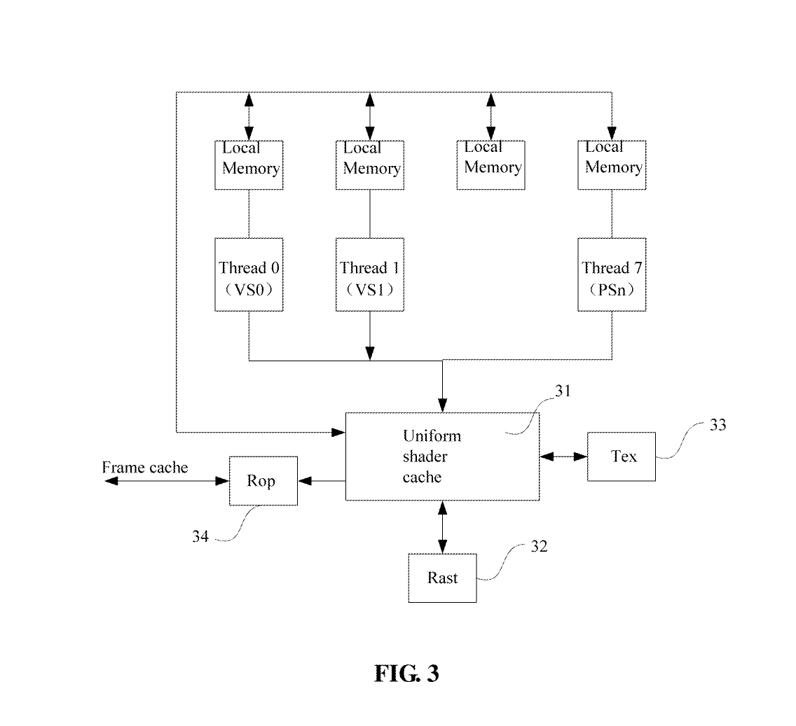

FIG. 3 shows a schematic diagram illustrating the structure of an interface used for a graphics programmable function processing module and a graphics fixed function processing module during a graphics data processing according to the embodiment. In FIG. 3, multiple thread processing engines are respectively connected with the local memories configured therein and synchronously connected with a shading memory 31 which is the L2 cache of the processor, and synchronously, the shading memory 31 is further respectively connected with a raster operator unit (ROP) 34, a texturing unit (TEX) 33 and a rasterizing unit (RAST) 32; in the embodiment, the ROP 34, the TEX 33 and the RAST 32 each form one part of the graphics fixed function processing module. Additionally, the L2 cache is also used during a program data processing. It can be seen that the processor described in the embodiment occupies the same unified storage space when serving as a CPU and a GPU and is therefore completely different from the conventional system provided with a CPU chip and a GPU chip.

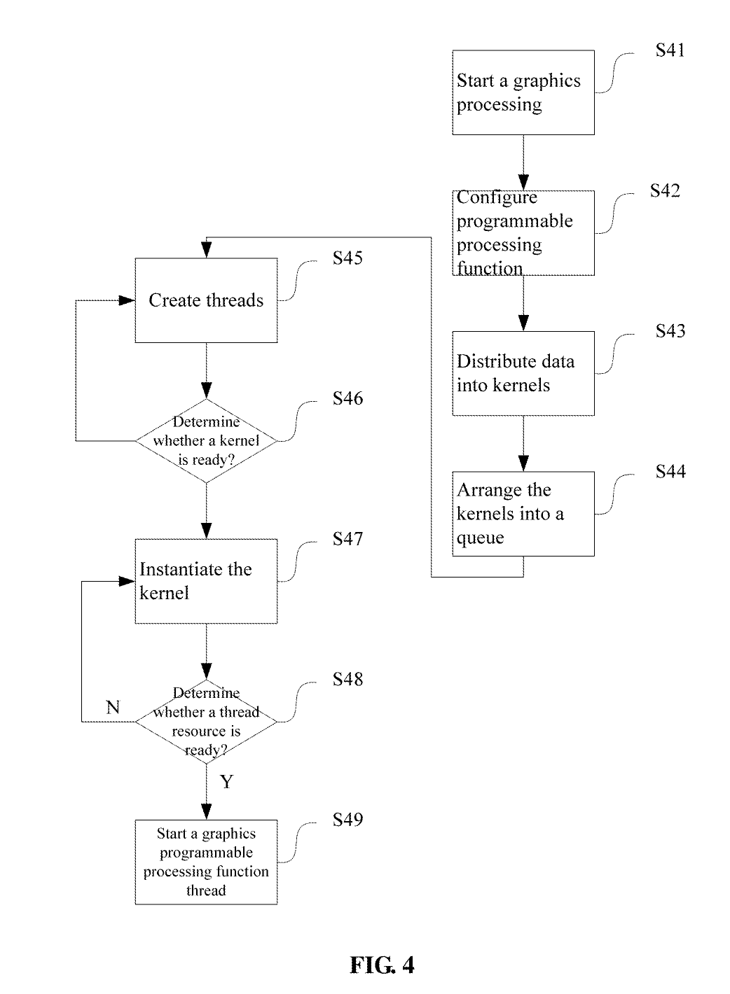

The embodiment further discloses a method for processing graphics data in the processor, which, as shown in FIG. 4, comprises the next steps of:

Step S41: starting a graphics processing: in the embodiment, as the processor synchronously has the functions of a CPU and a GPU, a task to be processed by the processor can be program data that is typically processed by a CPU or graphics data that is typically processed by a GPU. In the case where the task is program data that is typically processed by a CPU, the processor processes the task using the methods illustrated in the two aforementioned patent applications, and this task processing manner, although using a series of features of an MVP kernel, still belongs to the processing manner of a CPU in general sense; and in the case where the task is the graphics data that is typically processed by a GPU, the processor executes a main graphics processing program which is similar in task sense to the processing program of a CPU but different in specific steps. In this step, the main graphics processing program is activated to call the shading function (or known as shading function) of an OPENGL using an OPENGL CALL;

Step S42: configuring a programmable processing function: in this step, the OPENGL shading function called in the step above using OPENGL CALL is configured, wherein the shading function may also be referred to as shader which is classified into a vertex shader and a pixel shader which are respectively used for, performing, on graphics data, a vertex shading and a pixel shading that are the two most important processing steps in a programmable function processing on graphics data. The configured shaders are sent to the thread processing engines for processing the graphics data to guide or limit the thread processing engines carrying out a programmable function processing on the graphics data to process the data distributed thereto;

Step S43, distributing data into each kernel: in this step, the data of a task is distributed into multiple units so that the distributed data units can be processed by a thread to form a kernel; definitely, it is possible that the data to be processed by a task is stream data that is continuously sent, in this case, the received data is also distributed into multiple units so that the data contained in the units can just fill a local memory, then, the local memory can cooperate with an idle thread to realize a programmable processing function on the graphics data. In the embodiment, the programmable processing on the graphics data is actually identical to a user program processing in a CPU and is substantially identical, in terms of method, to the user program processing of a CPU if a shader is deemed as the user program, the only difference lies in the calling process and a possible need of a fixed function processing on the processed data. It should be noted that if the data length of the task is too long in this step, it is needed, after step S49 is executed and the currently distributed data is processed, to return to this step to divide the data unprocessed by the task and repeat the steps below until the task is completed. It should also be noted that the data processed by a central processing unit is also distributed in the way described in this step or this step also exists in the conventional data or task processing of a central processing unit. In other words, the data is distributed into the kernels only as data during the data distribution of this step, taking no account of whether the data is conventionally processed by a CU or GPU; in addition, the data processing manner, namely, the aforementioned calling of a main graphics processing program, is set, and the only difference in a CPU data or task processing lies in the called main program, which is exactly one of the differences of the present invention from a conventional CPU combined GPU structure. In the embodiment, the steps S41-S49 of a graphics data processing performed by a GPU are separately list only for the sake of a clear description, however, the conventional data or task processing of a CPU is mixed with but not separated from that of a GPU, and the processing process is also substantially identical to the steps S41-S49 but slightly different in that the called is a program or configuration content needed by the CPU data or task but not the main program or configuration content for the graphics processing described in steps S41 and S42 and that the processed data is subjected to a required processing but not sent to the graphics fixed function module to be processed. In conclusion, for the system, the data or task processed by the CPU and the GPU are the same, the only difference lies in the used processing method (or the called processing program). Additionally, in virtue of the parallelism of the threads of the system, multiple threads in the system can process a conventional CPU task and a conventional GPU task synchronously;

Step S44: arranging kernels into a queue: in this step, the kernels obtained from the steps above are queued according to the data arrival order thereof to be processed, and the kernels in the kernel queue formed in this step are sequentially taken out and processed if threads are established and there is an idle thread engine;

Step S45: creating threads: threads are established in this step; the establishment of the threads refers to the configuration of the kernels and shaders obtained in the steps above into idle thread engines so that the thread engines can process the data using a given shading function;

Step S46: determining whether or not a kernel is ready, if so, executing the next step, otherwise, repeating this step; in this step, there are two standards for determining whether a kernel is ready: 1, determining whether or not the data input into the kernel is ready; and 2: determining whether or not the storage space output by the kernel is ready; the kernel is considered ready if the two conditions are met and unready if either of the two conditions is not met;

Step S47: instantiating the kernel: in this step, the instantiation of the kernel refers to the transmission of the shader and data onto a selected thread engine so that the shader and data can reside in the thread engine in an executable manner;

Step S48: determining whether or not a thread resource is ready, if so, executing the next step, otherwise, repeating this step; in the embodiment, the ready of the thread resources refers to the ready of the thread engine; and

Step S49: starting a graphics programmable function processing on threads: in this step: the thread engines start to execute the configured threads to perform a vertex shading or pixel shading on graphics data; in the embodiment, as graphics processing programs are different, the shadings on the graphics data configured in the kernels are different, for instance, the data may need a pixel shading in addition to a vertex shading in some cases and either a vertex shading or a pixel shading in other cases; in the case where the data needs both a vertex shading and a pixel shading, the local storage unit will be further configured in another shading thread to perform another shading.

If the graphics data needs a further fixed function processing after the programmable function processing is completed, the data subjected to the shading processing is sent, by the L2 cache, to a fixed function processing module to subject to a fixed function processing. In the embodiment, the data transmission is realized through a Store instruction. And similarly, if it is needed to configure the data subjected to the processing of the fixed function processing module into the thread, then the fixed function processing module returns the data via the L2 cache and informs the thread of the data in an interruptible manner.

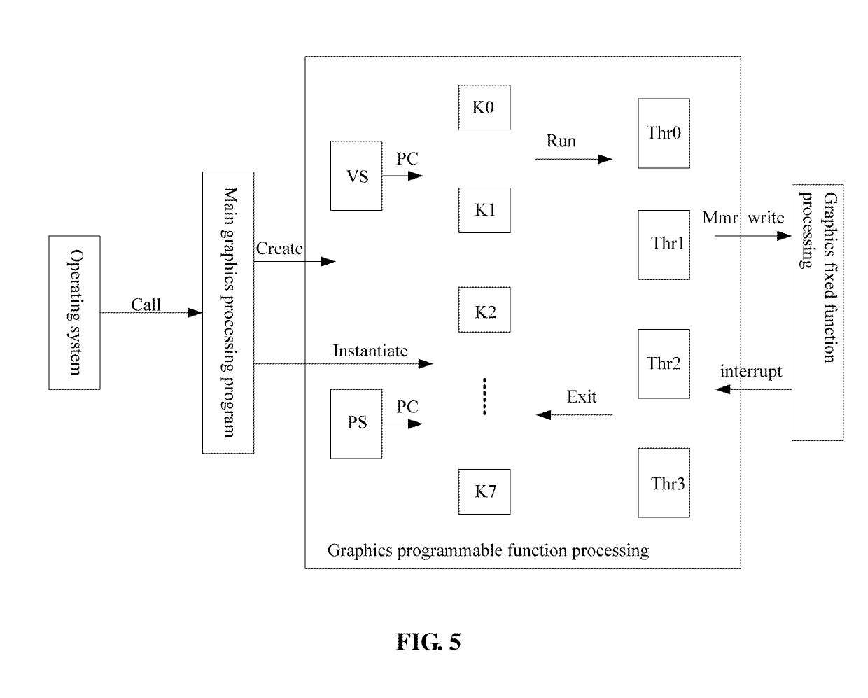

FIG. 5 shows a schematic diagram illustrating the relationship among a system, a main graphics processing program, a shader, a kernel, a thread and a fixed function processing module during a graphics data processing as well as the relationship among the entry into a main graphics processing program from an operating system, the setting of a vertex shading (vs) and a pixel shading (ps), the distribution of data into multiple kernels, and the establishment of multiple threads and an external graphics data fixed function processing module. FIG. 5 further shows eight kernels (K0-K8) and four threads (Thr0-Thr3) which are used for processing graphics data and realizing a programmable function processing on graphics data.

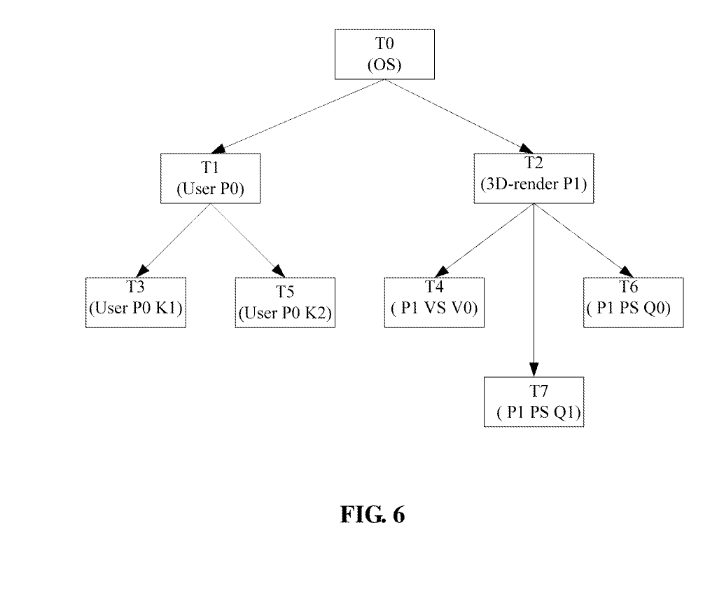

FIG. 6 shows the working of the eight thread engines included in the two MVP kernels at a given moment in the embodiment, in FIG. 6, thread 0 is used for running an operating system, thread 1 is used for running a program 0 (that is, USER P0), thread 3 (USER P0 K0) and thread 5 (USER P0 K1) are respectively used for running two functions in the user program P0, wherein USER P0 K0 represents the zeroth function of the user program P0, and USER P0 K1 represents the first function of the user program P0; thread 2 is used for a 3D render P1, that is, thread 2 is used for running a rendering program P1 for a graphics progressing, synchronously, threads 4, 6 and 7 are respectively used for the zeroth data (P1 VS K0) in the vertex shading of the program P1; and threads 6 and 7 are respectively used for the zeroth data (P1 PS Q0) and the first data (P1 PS Q1) in the pixel shading of the program P1. It can be observed from the description above that not only the shaders but also the aforementioned common user program and graphics data processing program are parallel. Therefore, it can further be obtained that the eight thread engines in the MVP kernels can achieve an excellent load balance between the system program and the graphics processing program. Certainly, FIG. 6 only exemplarily indicates the working states of thread engines, it should be appreciated that the eight thread engines are not necessarily in these working states in other embodiments or at another moment of the embodiment, for instance, the eight engines may be processing a user program of a CPU or a graphics user program of a GPU.

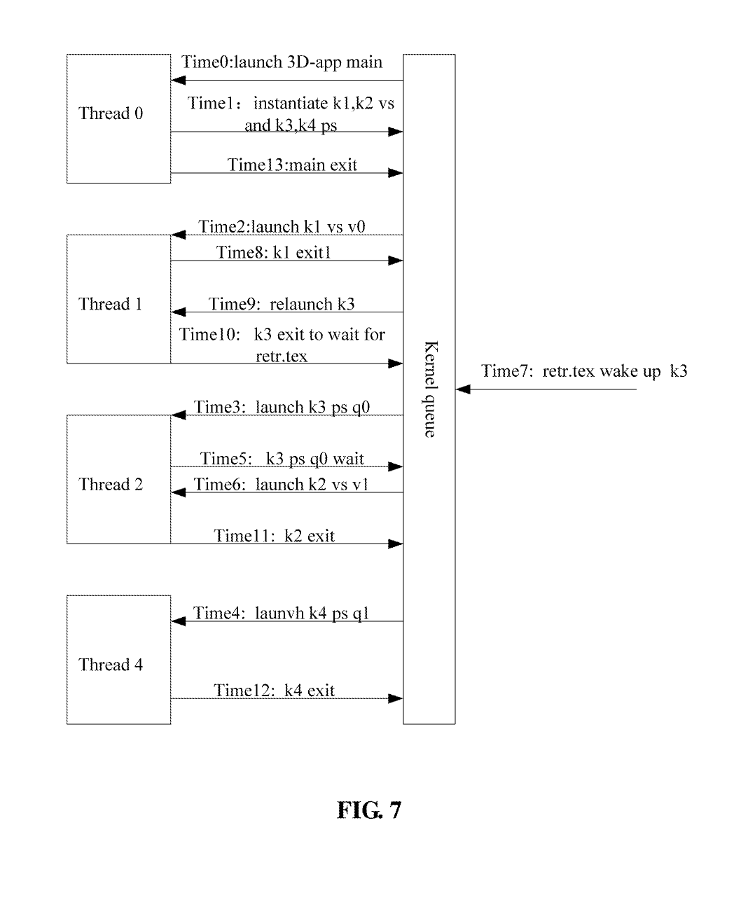

FIG. 7 is a schematic diagram illustrating the workflow for a 3D processing within a period of time in the embodiment; FIG. 7 still shows a data exchange among four thread engines, the kernel queue and the graphics fixed function processing module within 14 clock periods (Time 0-Time 13) and the flows of the data exchange. As shown in FIG. 7, it is not necessary that a processor processes the motions on the same thread engine in two neighboring clock periods, therefore, for the processor, the working of the thread engines are parallel. In FIG. 7:

in Time 0, Time0:launch 3D-app main, that is, thread 0 or thread engine 0 starts a main 3D application program;

in Time 1, Time1: instantiate k1,k2 vs and k3,k4 ps, that is, the data k1 and k2 needing a vs and the data k3 and k4 needing a ps are synchronously instantiated on thread 0;

in Time 2, Time2:launch k1 vs v0, that is, the k1 needing a vs is loaded in thread 1 and then an operation or processing is launched;

in Time 3, Time3:launch k3 ps q0, that is, the k3 needing a ps is loaded in thread 2;

in Time 4, Time4:launvh k4 ps q1: the data k4 needing a ps is loaded in thread 3, such loads occurring between a thread and the kernel queue;

in Time 5, Time5:k3 ps q0 wait, the data (k3 ps q0) on thread 2 needing a ps begins to wait;

in Time 6, Time6:launch k2 vs v1, that is, the data k2 needing a vs processing is uploaded on thread 2, at this time, as the k3 is in a waiting state, thread 2 is idle, another kernel data k2 is loaded and processed;

in Time 7, Time7:retr.tex wake up k3, the fixed function processing module sends an interruption request, returns the result of a texturing processing, and wakes up the waiting kernel k3;

in Time 8, Time8: k1 exit, the k1 is completely processed in thread 1 and then exits;

in Time 9, Time9:relaunch k3, as the data k1 exits in the former clock period and the thread 1 becomes idle, the data waiting on the thread 2 is re-uploaded on the thread 1, therefore, a real-time scheduling between threads is realized and a dynamic balance is consequentially achieved in the loads of the thread engines;

in Time 10, Time10:k3 exit to wait for retr.tex, the data k3 exits on the thread 1 and waits for the result of the processing of the fixed function processing module;

in Time 11, Time11:k2 exit, the k2 is completely processed in thread 2 and then exits;

in Time 12, Time11:k4 exit, the k4 is completely processed in thread 4 and then exits; and

in Time 13, Time13:main exit, the entire 3D-app main is completely processed in thread 0 and then exits.

It is clearly explicated in the description above how a vertex shading and a pixel shading are realized in a graphics application processing program using thread engines, how the multiple kernels run and achieve a dynamic balance among the multiple thread engines, and how a data transmission is realized between the programmable function processing part and the fixed function processing part.

The aforementioned embodiments, although described in a specific and detailed way, are only illustrative of several specific implementation modes of the present invention, and are not to be construed as limiting the scope of the present invention. It should be noted that various modifications and improvements can be devised by those of ordinary skill in the art without departing from the scope of the present invention, and that such modifications and improvements belong to the protection scope of the present invention. Therefore, the scope of the protection the present invention is determined by the appended claims.

What is claimed is:

1. A multithreaded processor for realizing the functions of a central processing unit and a graphics processing unit, comprising:
a graphics fixed function processing module performing a fixed function processing on data during a graphics processing;
a multithreaded parallel central processing module for realizing a central processing function and a programmable processing function of a graphics processing through a uniform thread scheduling and exchanging the graphics data subjected to the programmable processing with the graphics fixed function processing module through a storage module; and
a storage module for providing a uniform storage space for the graphics fixed function processing module and the multithreaded parallel central processing module to store, buffer and/or exchange data.

2. The multithreaded processor according to claim 1, wherein the multithreaded parallel central processing module is a multithreaded virtual pipeline processor.

3. The multithreaded processor according to claim 2, wherein the multithreaded virtual pipeline processor comprises two parallel multithreaded virtual pipeline processing kernels.

4. The multithreaded processor according to claim 3, wherein the multithreaded virtual pipeline processing kernels both comprise:
multiple parallel thread processing engines for processing a task or thread distributed thereto;
a thread controller for acquiring, determining and controlling the states of the multiple thread processing engines and distributing the threads or tasks in a waiting queue to the multiple thread processing engines;
a local storage area for storing the data processed by the thread processing engines and cooperating with the thread processing engines to complete a data processing; and
a register for the data buffering and the instruction buffering of an internal storage system and the storage of various states of the parallel processor.

5. The multithreaded processor according to claim 4, wherein the thread processing engine comprises an arithmetical logic operation unit and a multiplier-adder corresponding to the arithmetical logic operation unit, and the local storage area comprises multiple local storage units which are configured to correspond to the thread processing engines when the thread processing engines are running.

6. The multithreaded processor according to claim 1, wherein the graphics fixed function processing module is an independent ASIC which exchanges data with the multithreaded parallel central processing module via the storage module.

7. The multithreaded processor according to claim 6, wherein the multithreaded parallel central processing module is a multithreaded virtual pipeline processor.

8. The multithreaded processor according to claim 7, wherein the multithreaded virtual pipeline processor comprises two parallel multithreaded virtual pipeline processing kernels.

9. The multithreaded processor according to claim 8, wherein the multithreaded virtual pipeline processing kernels both comprise:
multiple parallel thread processing engines for processing a task or thread distributed thereto;
a thread controller for acquiring, determining and controlling the states of the multiple thread processing engines and distributing the threads or tasks in a waiting queue to the multiple thread processing engines;
a local storage area for storing the data processed by the thread processing engines and cooperating with the thread processing engines to complete a data processing; and
a register for the data buffering and the instruction buffering of an internal storage system and the storage of various states of the parallel processor.

10. The multithreaded processor according to claim 9, wherein the thread processing engine comprises an arithmetical logic operation unit and a multiplier-adder corresponding to the arithmetical logic operation unit, and the local storage area comprises multiple local storage units which are configured to correspond to the thread processing engines when the thread processing engines are running.

11. The multithreaded processor according to claim 6, wherein the programmable processing on graphics data comprises a vertex shading and/or a pixel shading on graphics data; and the graphics fixed function processing module is connected with the multithreaded parallel central processing module via an L2 cache.

12. The multithreaded processor according to claim 11, wherein the multithreaded parallel central processing module is a multithreaded virtual pipeline processor.

13. The multithreaded processor according to claim 12, wherein the multithreaded virtual pipeline processor comprises two parallel multithreaded virtual pipeline processing kernels.

14. The multithreaded processor according to claim 13, wherein the multithreaded virtual pipeline processing kernels both comprise:
multiple parallel thread processing engines for processing a task or thread distributed thereto;
a thread controller for acquiring, determining and controlling the states of the multiple thread processing engines and distributing the threads or tasks in a waiting queue to the multiple thread processing engines;
a local storage area for storing the data processed by the thread processing engines and cooperating with the thread processing engines to complete a data processing; and
a register for the data buffering and the instruction buffering of an internal storage system and the storage of various states of the parallel processor.

15. The multithreaded processor according to claim 14, wherein the thread processing engine comprises an arithmetical logic operation unit and a multiplier-adder corresponding to the arithmetical logic operation unit, and the local storage area comprises multiple local storage units which are configured to correspond to the thread processing engines when the thread processing engines are running.

16. The multithreaded processor according to claim 11, wherein the graphics fixed function processing module is controlled by, or sends an interruption request to the multithreaded parallel central processing module via an interruption control interface configured in the multithreaded parallel central processing module.

17. The multithreaded processor according to claim 16, wherein the multithreaded parallel central processing module is a multithreaded virtual pipeline processor.

18. The multithreaded processor according to claim 17, wherein the multithreaded virtual pipeline processor comprises two parallel multithreaded virtual pipeline processing kernels.

19. The multithreaded processor according to claim 18, wherein the multithreaded virtual pipeline processing kernels both comprise:
multiple parallel thread processing engines for processing a task or thread distributed thereto;
a thread controller for acquiring, determining and controlling the states of the multiple thread processing engines and distributing the threads or tasks in a waiting queue to the multiple thread processing engines;
a local storage area for storing the data processed by the thread processing engines and cooperating with the thread processing engines to complete a data processing; and
a register for the data buffering and the instruction buffering of an internal storage system and the storage of various states of the parallel processor.

20. The multithreaded processor according to claim 19, wherein the thread processing engine comprises an arithmetical logic operation unit and a multiplier-adder corresponding to the arithmetical logic operation unit, and the local storage area comprises multiple local storage units which are configured to correspond to the thread processing engines when the thread processing engines are running.

21. A data processing method for realizing the functions of a central processing unit and a graphics processing unit, comprising the next steps of:
A) executing a main graphics processing application program while continuing other central processing application programs;
B) generating multiple tasks or data by the main graphics processing application program;
C) distributing the graphics data or task to be processed and other central processing application programs into multiple kernels and establishing a kernel queue;
D) determining whether or not a kernel is ready, if so, executing the next step, otherwise, repeating this step;
E) determining whether or not a thread resource is ready to run the kernel, if so, instantiating the kernel and executing the next step, otherwise, repeating this step; and
F) performing a programmable function processing on the data or risk.

22. The data processing data processing method according to claim 21, further comprising a step of:
G) performing a fixed function processing on the graphics data subjected to the programmable function processing; or
H) performing a programmable function processing on the graphics data subjected to the fixed function processing.

23. The processing data processing method according to claim 22, wherein the programmable function processing comprises a vertex shading and/or a pixel shading, and the fixed function processing comprises latticing, texturing and rasterizing.

24. The data processing data processing method according to claim 23, wherein the step C) further comprises the next steps of:
C1) distributing the graphics data to be processed to idle kernels and configuring a shader to process the graphics data in the kernels; and
C2) arranging the kernels into a kernel queue to be processed.

25. The data processing method according to claim 24, wherein the step D) further comprises the next steps of:
D1) determining whether or not there is an idle thread resource, if so, executing the next step, otherwise, repeating this step; and
D2) configuring the kernels in the queue to the thread resource and starting to run the thread resource.

26. The data processing data processing method according to claim 25, wherein the graphics data fixed function processing module is a hardware structure which is independent from the kernels of the processor and connected with the kernels of the processor via the L2 cache of the processor.

27. The processing data processing method according to claim 26, wherein the step G) further comprises the next steps of:
G1) sending the graphics data subjected to the programmable function processing to the L2 cache; and
G2) reading, by the graphics data fixed function processing part, data from the L2 cache, and processing the data.

28. The data processing data processing method according to claim 27, wherein in the step H), the graphics data fixed function processing part sends an interruption signal to the processor so as to send the graphics data to the processor by reading the data in the L2 cache to enable a programmable function processing.
